(19) United States
(12) Patent Application Publication
(10) Pub. No.: US 2009/0271523 A1
(43) Pub. Date: Oct. 29, 2009

(54) System, Method and Software for Using One Computer Network to Bypass a Portion of Another Computer Network

(76) Inventors: Darrell Gentry, Mountain View, CA (US); Nathan Burns, San Francisco, CA (US)

Correspondence Address: HARNESS, DICKEY, & PIERCE, P.L.C, 7700 Bonhomme, Suite 400, ST. LOUIS, MO, 63105, US

(21) Appl. No.: 12/325,785

(22) Filed: Dec. 1, 2008

Related U.S. Application Data
(60) Provisional application No. 60/991,295, filed on Nov. 30, 2007.

(51) Int. Cl. G06F 15/173; H04L 9/32

(52) U.S. Cl. 709/228; 726/12

(57) ABSTRACT

A bypass computer network allows data communications between a client computing device and a remote content source to be selectively routed around a portion of the public Internet (or other computer network(s)) via the bypass network without requiring a physical connection between the bypass network and either the client computing device or the content source.

### CROSS REFERENCE TO RELATED APPLICATION

This application claims the benefit of U.S. Provisional Application No. 60/991,295 filed Nov. 30, 2007, the entire disclosure of which is incorporated herein by reference.

### DESCRIPTION

In some embodiments, the bypass network is a private Internet Protocol (IP) communications network comprising nodes in two or more geographic locations (e.g., in different cities or States) interconnected by private IP communication links. Each node preferably includes an ingress gateway (for entering the bypass network) and an egress gateway (for exiting the bypass network) that are connected to the private IP communications network and also connected to other public or private network(s), such as the public Internet. Clients of the bypass network connect to (and receive data back from) the ingress gateways using a tunneling protocol (to establish a virtual connection through a physical connection) such as Internet protocol 4 (also referred to as “ipencap” or “IP within IP tunneling”) or other suitable means. These connections allow client data to transit the bypass network. Egress gateways are used when the destination end of the IP communication conversation (e.g., a computer server) is not a client of the bypass network. In that event, traffic is directed from the bypass network to another computer network, such as the public Internet, through the egress gateways (and preferably through the egress gateway positioned closest to the content server) via peering connections between the egress gateways and network routers. The egress gateways may use Network Address Translation (NAT) to provide a return path from the non-bypass computer network (e.g., the Internet) back to the same egress gateway and subsequently through the bypass network back to the originating client. The egress gateways may also use state-full packet inspection to ensure that only outgoing IP conversations are taking place, i.e., that the packets received back by the egress gateway are in response to conversations which originated on the bypass network.

Each client computing device has a physical connection to a data network (e.g., to a network access provider, such as an Internet Service Provider (ISP)). The ingress gateways can work cooperatively with software installed on the client computing devices. The software may be a simple tunneling program to direct traffic to the ingress gateway, or may be an intelligent dynamic or non-dynamic routing program that decides whether and when to use the bypass network for accessing a remote content server (e.g., based on a user selection, user-specified rules, the type of data to be transmitted, the intended data destination, latency to destination, etc.).

The bypass network can have its own physical infrastructure, or it can be a virtual private network operating on the physical infrastructure of one or more other networks, such as the Internet, or it can be a combined physical and virtual network.

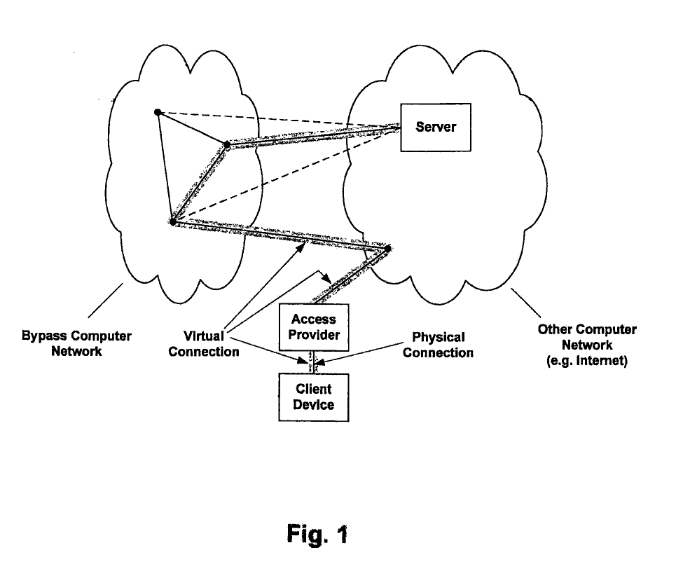

FIG. 1 illustrates one example of a client computing device using a physical connection to a network access provider (e.g., an ISP) to establish a virtual connection to a bypass network. As shown in FIG. 1, the bypass network can receive, via the virtual connection, a data request seeking content from a server residing on another computer network, which may be the Internet. The bypass network routes the data request to the server through a portion of the bypass network and through a portion of the other network (as indicated by the gray line in FIG. 1). The same data path may be and preferably is used for providing the requested data from the server back to the client. While the bypass network is illustrated as a physically distinct network in FIG. 1, it should be understood that the bypass network may be, at least in part, a virtual network operating on the physical infrastructure of one or more other networks, such as the other computer network shown in FIG. 1.

By using the bypass network to route around a portion of the Internet (or other computer network(s)), a client can minimize the data transit path through the Internet (or other computer network(s)) for improved performance (e.g., reduced latency, jitter, etc.) or a more reliable or consistent data communication experience (e.g., more consistent ping times, reduced number of hops between the client and a content server, etc.).

The teachings of this disclosure can be applied, for example, to on-line video gaming applications in which clients communicate with remote video game servers (e.g., in different cities and/or states than the client) over a portion of the Internet. It should be understood, however, that the teachings of this disclosure are not so limited and can be applied to a wide variety of data communication applications.

The above description should be construed as exemplary only and does not describe every possible instance of the system. Numerous alternatives could be implemented, using combinations of current or future technologies, which would still fall within the scope of the claims. As just one example, the bypass network may be a public (rather than private) computer network.

1. A method of using a first computer network to bypass a portion of a second computer network when accessing resources from the second computer network, the method comprising:
establishing a connection between the first computer network and a client computer;
receiving a data request from the client computer via the established connection, said data request seeking content from a server residing on the second computer network; and
routing the data request to said server through a portion of the first computer network and a portion of the second computer network.

2. The method of claim 1 wherein the first computer network is a private network.

3. The method of claim 2 wherein the first computer network is a virtual private network.

4. The method of claim 3 wherein the virtual private network is configured for operating on the physical infrastructure of the second network.

5. The method of claim 1 wherein the second computer network is the Internet.

6. The method of claim 1 wherein the second computer network is a private network

7. The method of claim 1 wherein establishing includes establishing a data tunnel between the first computer network and the client computer.

8. The method of claim 7 wherein establishing further includes establishing said data tunnel through the second computer network.

9. The method of claim 7 wherein establishing further includes establishing said data tunnel through a third computer network.

10. The method of claim 1 wherein said connection is an Internet Protocol (IP) connection.

11. The method of claim 1 wherein said content relates to a computer game.

12. The method of claim 1 wherein the first computer network includes an ingress gateway and an egress gateway, wherein establishing includes establishing said connection between the ingress gateway and the client computer, and wherein routing includes routing said data request from the ingress gateway to the egress gateway through said portion of the first computer network, and routing said data request from the egress gateway to the server through said portion of the second computer network.

13. The method of claim 12 further comprising performing network address translation on the data request at the egress gateway.

14. The method of claim 12 wherein the first computer network includes a plurality of egress gateways, one of said egress gateways positioned closer to said server as compared to other egress gateways, and wherein routing includes routing said data request from the ingress gateway to said egress gateway positioned closer to said server.

15. The method of claim 1 wherein the client computer and said server are located in different cities.

16. A method of using a first computer network to bypass a portion of a second computer network when accessing resources from the second computer network, the method comprising transmitting, to the first computer network, a data request seeking content from a server residing on the second computer network.

17. The method of claim 16 wherein transmitting includes transmitting the data request to the first computer network via a data tunnel.

18. (canceled)

19. A bypass computer network comprising data connections between two or more cities, at least one private network ingress point and at least one private network egress point, multiple interconnection points, and a software program installed on at least one computing device that allows data between said computing device and a content source to bypass some or all of the public Internet.

20. (canceled)

21. The computer network of claim 20 wherein said another computer network is the Internet.

22. (canceled)
